(19) United States
(12) Patent Application Publication
(10) Pub. No.: US 2024/0242549 A1
(43) Pub. Date: Jul. 18, 2024

(54) SYSTEMS AND METHODS FOR CAPTURING AND UTILIZING VEHICULAR DATA

(71) Applicant: Foundation Automotive US Corp, Houston, TX (US)

(72) Inventor: Cole Kutschinski, Tomball, TX (US)

(73) Assignee: Foundation Automotive US Corp, Houston, TX (US)

(21) Appl. No.: 18/413,474

(22) Filed: Jan. 16, 2024

Related U.S. Application Data
(60) Provisional application No. 63/479,993, filed on Jan. 14, 2023.

(51) Int. Cl. G07C 5/08; G06Q 30/0601

(52) U.S. Cl. CPC G07C 5/085; G06Q 30/0633

(57) ABSTRACT

A method and system which captures and uses vehicular registration information within a larger schema to render particularized services to a registrant of a vehicle is provided.

### CROSS REFERENCE TO RELATED APPLICATIONS

This application claims priority benefit of US Provisional Application No. 63/479,993 filed Jan. 14, 2023, entitled SYSTEMS AND METHODS FOR CAPTURING AND UTILIZING VEHICULAR DATA, which is entirely incorporated by reference herein.

### TECHNICAL FIELD

This application relates generally to capturing information pertaining to personal and commercial vehicles and using such information to provide one or more services to users and/or owners of such vehicles.

### BACKGROUND

When an operator of a motor vehicle presents that motor vehicle for service, (e.g., to have the vehicle cleaned), information pertaining to the purchaser of the service is sometimes gathered. However, information concerning the vehicle itself (e.g., license plate number) is not collected. Attempts to gather and track particularized vehicular data have not been wholly successful. Thus, there is room for improvement in the art.

### SUMMARY

An example of this is a method for capturing and using vehicular data, the method comprising: a. capturing image data corresponding to a vehicle, such as the condition of the vehicle; b. registration information corresponding to the vehicle; c. determining, based at least in part on the registration information, an identity of a party to whom the vehicle is registered; and d. prompting, using an electronic device, the party having been so identified to provide additional information associated with the vehicle via the electronic device.

Another example of this disclosure is an electromechanical system configured to: a. capture image data corresponding to a vehicle; b. registration information corresponding to the vehicle; c. determining, based at least in part on the registration information, an identity of a party to whom the vehicle is registered; and d. prompt, using an electronic device, the party having been so identified to provide additional information associated with the vehicle via the electronic device.

### BRIEF DESCRIPTION OF THE DRAWINGS

For illustration, there is shown in the drawing certain examples described in the present disclosure. In the drawing, like numerals indicate like elements throughout. The scope of the inventions disclosed is not limited to the precise arrangements and instruments shown.

FIG. 1 illustrates a method for capturing and utilizing vehicular data, in accordance with an example of this disclosure.

FIG. 2 illustrates a system for capturing and using vehicular data, in accordance with an example of this disclosure.

### DETAILED DESCRIPTION

In the drawing and related description, certain terminology is used for convenience and is not to be taken as limiting the examples of the present disclosure.

Embodiments of this disclosure are directed to a situation in which a driver of a vehicle approaches a car wash and is invited through an electronic mechanism to receive information (e.g., messages) while providing personal and/or contact information. An image capture device at the car wash (or other suitable location) captures the license plate and/or vehicle identification number (VIN) of the vehicle.

Under National Highway Traffic Safety Administration regulations, each motor vehicle must contain a VIN, which is a 17-character number that encodes specific information about a particular vehicle. The VIN is used to locate information about the vehicle (e.g., service records, government registrations). In some cases, the VIN is displayed on the exterior of a vehicle. This vehicular information can in turn be used to garner or infer information which is tailored to the user of the vehicle having the VIN. For example, where a person chooses to wash a vehicle can be an indicator of where that person lives, where that person works, and that person's income level.

A vehicle registration plate, which may be a license plate, is a metal or plastic plate attached to a motor vehicle or trailer for identification purposes. A vehicle registration plate displays a registration identifier. The registration identifier is a numeric or alphanumeric ID that uniquely identifies the vehicle or vehicle owner within the issuing region's vehicle register.

In an embodiment of this disclosure, a driver of a vehicle presents the vehicle at a car wash. In turn, in at least one embodiment, a registration identifier or VIN displayed on the vehicle is captured by one or more capture devices, such as a camera. It some embodiments, an electronic identifier of the vehicle (such as a Bluetooth identifier) corresponding to the vehicle may be detected. Such unique vehicle information can be used to look up public information pertaining to the vehicle. For example, the registration number could be used to identify the person or entity who owns the vehicle. At the same time, or in some instance as an alternative, the operator of the vehicle may be prompted to download an application to his cell phone or other electronic device. The application may request personal or other identifying information and in return the operator may be offered perks or benefits for providing the requested information, such as a free car wash. In other embodiments, the operator may be prompted to enter information on a local screen at the car wash. As with the mobile device, the local screen may request personal or other identifying information, in return the operator may be offered perks or benefits for providing the requested information, such as a free car wash.

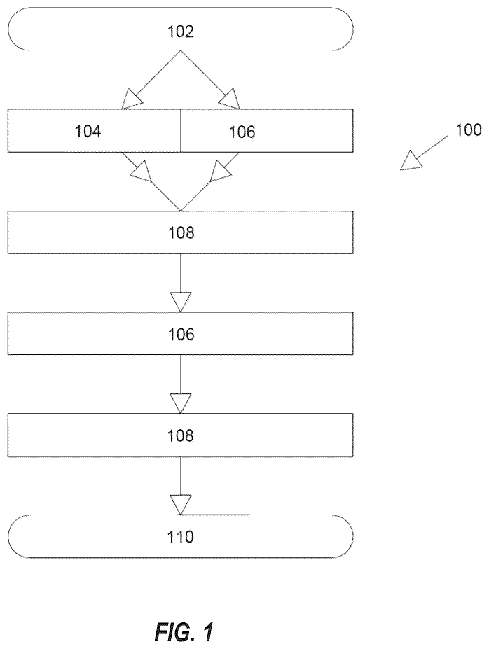

FIG. 1 illustrates a method 100 for capturing and using vehicular data. The method 100 comprises: capturing 102 image data corresponding to a vehicle, the image data comprising the condition of the vehicle, capturing 104 electronic registration information corresponding to the vehicle; and/or capturing 106 image registration information corresponding to the vehicle, determining 108, based at least in part on the registration information, an identity of a party to whom the vehicle is registered; and prompting 110, using an electronic device, the party so identified to provide additional information associated with the vehicle via the electronic device.

In some embodiments of this disclosure, an image capture device can be used to capture 102 one or more images depicting the vehicle. Information in the one or more images can indicate the general condition of the vehicle such as that the paint on a vehicle has been damaged. A system of this disclosure can be configured to prompt 110 the owner of the vehicle (corresponding to the registration identifier, for example) to take the vehicle to a particular repair shop to have the damage repaired. Information in the one or more images can indicate that it may be appropriate to replace the vehicle (e.g., because the vehicle is damaged or in poor condition). A system of this disclosure can be configured to prompt 110 the owner of the vehicle (corresponding to the registration identifier, for example) to a proprietor (such as a car dealership) that could provide the owner with a replacement vehicle. In some embodiments of this disclosure, the captured 102 and 104 information can be evaluated using one or more artificial intelligence techniques.

In at least one embodiment, captured 102 image data corresponding to a vehicle can indicate that the vehicle is being well maintained. In that case, a system of this disclosure may recommend to a warranty holder that the warranty holder offer to extend the warranty covering the vehicle in question.

In at least one embodiment of this disclosure, a customer profile can be created. For example, multiple vehicle registrations, and hence multiple vehicles, can be assigned to a customer account. In some embodiments, multiple vehicles can be assigned to a particular phone number or credit card number or account number. Information concerning the vehicle(s) can be used to extrapolate additional information about the owner or even the user of the vehicle. This additional information can be filtered and aggregated with information from other vehicle owners and be used for direct marketing purposes.

In some embodiments of this disclosure, captured 102 images can be used to verify that a particular vehicle is being presented for a particular service. For example, a car wash user may have two vehicles registered to an account. When a user presents a vehicle at a car wash, the license plate information (registration identifier) can be scanned, enabling the system to confirm that the vehicle presented is one of the two vehicles registered to the account. Thus, the registration identifier can be part of a system architecture for protecting the car wash proprietor from fraud or unapproved use.

In at least one embodiment of this disclosure, when a vehicle is presented at a car wash or other service location for service, the license plate information (registration identifier) or VIN can be scanned and a message will be sent to an electronic device of a registered user prompting 110 the registered user to confirm that he has presented the vehicle for service. Again, the vehicular information can serve as a component of a system to prevent a current possessor of a vehicle from improperly charging the owner of an account for services (e.g., a fee for cleaning the vehicle).

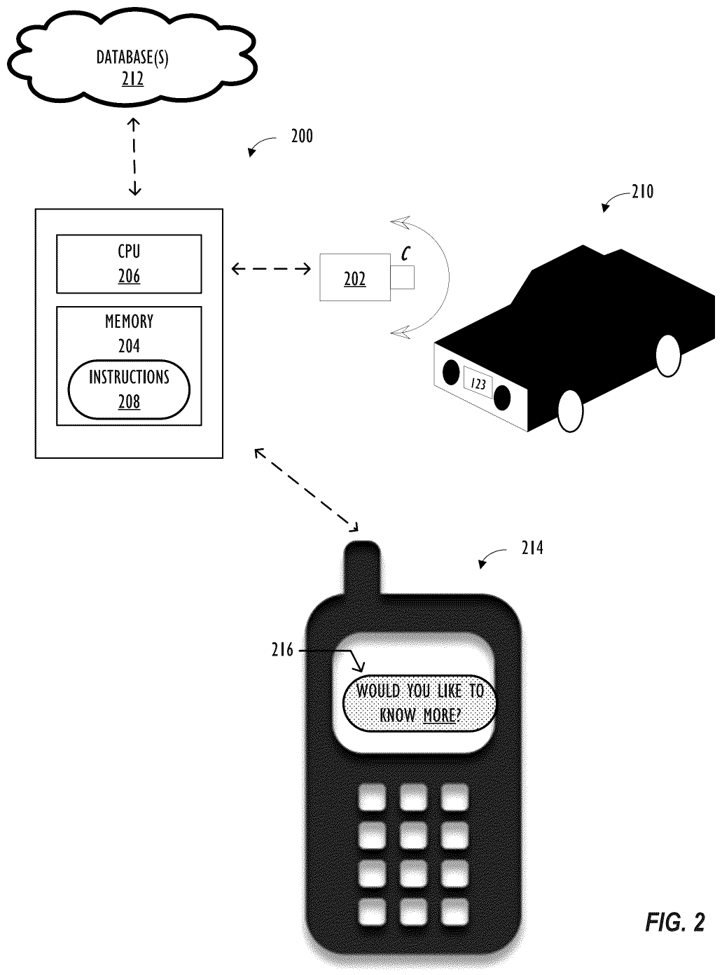

FIG. 2 illustrates a system 200 for capturing and using vehicular data in accordance with an embodiment of this disclosure. The system includes a scanning device 202, (e.g., a camera), a memory 204, and a processor (CPU) 206 which is in signal communication with the scanning device and the memory. The memory stores instructions (e.g., code) which are executed by the processor and which cause the processor to control the scanning device to capture image data corresponding to a vehicle 210, the image data comprising registration information corresponding to the vehicle.

The processor will determine 104, based at least in part on the registration information, an identity of a party to whom the vehicle is registered, e.g., the processor can access one or more databases such as a state-sponsored or national vehicle registry. The processor can then communicate with an electronic device 214 belonging to the person to whom the vehicle is registered. The processor can send a signal to the electronic device to prompt the registrant to provide additional information associated with the vehicle via the electronic device, such as by displaying a user-selectable prompt 216 as shown.

Additional embodiments of this disclosure include the following:

1. A method (100) for capturing and using vehicular data, the method (100) comprising: capturing (102) image data corresponding to a vehicle (210), the image data comprising registration information corresponding to the vehicle (210); determining (104), based at least in part on the registration information, an identity of a party to whom the vehicle (210) is registered; and prompting (106), using an electronic device (214), the party having been so identified to provide additional information associated with the vehicle (210) via the electronic device (214).

2. The method (100) of embodiment 1, wherein capturing (102) the image data corresponding to the vehicle (210) comprises scanning a license plate of the vehicle (210) at a car wash.

3. The method (100) of embodiment 1, wherein determining (104) the identity of the party to whom the vehicle (210) is registered comprises accessing a public database (212).

4. The method (100) of embodiment 1, wherein prompting (106) the party to provide additional information comprises offering one or more services in exchange for the additional information.

5. The method (100) of embodiment 4, wherein the one or more services comprise car cleaning services.

6. The method (100) of embodiment 1, further comprising conveying an offer to purchase the vehicle (210) or an invitation to make an offer to sell the vehicle (210) to the party so identified, using the electronic device (214).

7. A system (200) for capturing and using vehicular data, the system (200) comprising: a scanning device (202); a memory (204); a processor (206) in signal communication with the memory (204), the memory (204) storing instructions (208) executable by the processor (206), the instructions (208) comprising instructions (208) to: capture, using the scanning device (202), image data corresponding to a vehicle (210), the image data comprising registration information corresponding to the vehicle (210); determine (104), based at least in part on the registration information, an identity of a party to whom the vehicle (210) is registered; and prompt (106), using an electronic device (214), the party having been so identified to provide additional information associated with the vehicle (210) via the electronic device (214).

8. The system of embodiment 7, wherein the instructions (208) to capture the image data corresponding to the vehicle (210) comprise instructions (208) to scan a license plate of the vehicle (210) at a car wash.

9. The system of embodiment 7, wherein the instructions (208) to determine (104) the identity of the party to whom the vehicle (210) is registered comprise instructions (208) to access a public database (212).

10. The system of embodiment 7, wherein the instructions (208) to prompt (106) the party to provide additional information comprise instructions (208) to offer one or more services in exchange for the additional information.

11. The system of embodiment 10, wherein the one or more services comprise car cleaning services.

12. The system of embodiment 7, wherein the instructions (208) further comprise instructions (208) to convey an offer to purchase the vehicle (210) or an invitation to make an offer to sell the vehicle (210) to the party so identified, using the electronic device (214).

13. A non-transitory computer readable medium (204) storing instructions (208) executable by a processor (206), the instructions (208) comprising instructions (208) to: capture, using a scanning device (202), image data corresponding to a vehicle (210), the image data comprising registration information corresponding to a vehicle (210); determine (104), based at least in part on the registration information, an identity of a party to whom the vehicle (210) is registered; and prompt (106), using an electronic device (214), the party having been so identified to provide additional information associated with the vehicle (210) via the electronic device (214).

14. The non-transitory computer readable medium (204) of embodiment 13, wherein the instructions (208) to capture, using the scanning device (202), the image data corresponding to the vehicle (210) comprise instructions (208) to scan a license plate of the vehicle (210) at a car wash.

15. The non-transitory computer readable medium (204) of embodiment 13, wherein the instructions (208) to determine (104) the identity of the party to whom the vehicle (210) is registered comprise instructions (208) to access a public database (212).

16. The non-transitory computer readable medium (204) of embodiment 13, wherein the instructions (208) to prompt (106) the party to provide additional information comprise instructions (208) to offer one or more services in exchange for the additional information.

17. The non-transitory computer readable medium (204) of embodiment 16, wherein the one or more services comprise car cleaning services.

18. The non-transitory computer readable medium (204) of embodiment 13, wherein the instructions (208) further comprise instructions (208) to convey an offer to purchase the vehicle (210) or an invitation to make an offer to sell the vehicle (210) to the party so identified, using the electronic device (214).

The various examples set forth are provided by way of illustration and should not be construed to limit the scope of the disclosure. Various modifications and changes can be made to the principles and examples described herein without departing from the scope of the disclosure and without departing from the claims which follow.

What is claimed is:

1. A method for capturing and using vehicular data, the method comprising:
capturing image data corresponding to a vehicle, the image data comprising registration information corresponding to the vehicle;
determining, based at least in part on the registration information, an identity of a party to whom the vehicle is registered; and
prompting, using an electronic device, the party having been so identified to provide additional information associated with the vehicle via the electronic device.

2. The method of claim 1, wherein capturing the image data corresponding to the vehicle comprises scanning a license plate of the vehicle at a car wash.

3. The method of claim 1, wherein determining the identity of the party to whom the vehicle is registered comprises accessing a public database.

4. The method of claim 1, wherein prompting the party to provide additional information comprises offering one or more services in exchange for the additional information.

5. The method of claim 4, wherein the one or more services comprise car cleaning services.

6. The method of claim 1, further comprising conveying an offer to purchase the vehicle or an invitation to make an offer to sell the vehicle to the party so identified, using the electronic device.

7. A system for capturing and using vehicular data, the system comprising:
a scanning device;
a memory;
a processor in signal communication with the memory, the memory storing instructions executable by the processor, the instructions comprising instructions to:
capture, using the scanning device, image data corresponding to a vehicle, the image data comprising registration information corresponding to the vehicle;
determine, based at least in part on the registration information, an identity of a party to whom the vehicle is registered; and
prompt, using an electronic device, the party having been so identified to provide additional information associated with the vehicle via the electronic device.

8. The system of claim 7, wherein the instructions to capture the image data corresponding to the vehicle comprise instructions to scan a license plate of the vehicle at a car wash.

9. The system of claim 7, wherein the instructions to determine the identity of the party to whom the vehicle is registered comprise instructions to access a public database.

10. The system of claim 7, wherein the instructions to prompt the party to provide additional information comprise instructions to offer one or more services in exchange for the additional information.

11. The system of claim 10, wherein the one or more services comprise car cleaning services.

12. The system of claim 7, wherein the instructions further comprise instructions to convey an offer to purchase the vehicle or an invitation to make an offer to sell the vehicle to the party so identified, using the electronic device.

13. A non-transitory computer readable medium storing instructions executable by a processor, the instructions comprising instructions to:
capture, using a scanning device, image data corresponding to a vehicle, the image data comprising registration information corresponding to a vehicle;
determine, based at least in part on the registration information, an identity of a party to whom the vehicle is registered; and
prompt, using an electronic device, the party having been so identified to provide additional information associated with the vehicle via the electronic device.

14. The non-transitory computer readable medium of claim 13, wherein the instructions to capture, using the scanning device, the image data corresponding to the vehicle comprise instructions to scan a license plate of the vehicle at a car wash.

15. The non-transitory computer readable medium of claim 13, wherein the instructions to determine the identity of the party to whom the vehicle is registered comprise instructions to access a public database.

16. The non-transitory computer readable medium of claim 13, wherein the instructions to prompt the party to provide additional information comprise instructions to offer one or more services in exchange for the additional information.

17. The non-transitory computer readable medium of claim 16, wherein the one or more services comprise car cleaning services.

18. The non-transitory computer readable medium of claim 13, wherein the instructions further comprise instructions to convey an offer to purchase the vehicle or an invitation to make an offer to sell the vehicle to the party so identified, using the electronic device.
